(19) United States
(12) Patent Application Publication
(10) Pub. No.: US 2011/0292035 A1
(43) Pub. Date: Dec. 1, 2011

(54) IMAGE OUTPUT CONTROL APPARATUS AND IMAGE OUTPUT CONTROL METHOD

(76) Inventors: Tokuhiro Sakurai, Akishima-shi (JP); Teruo Kinoshita, Nishitama-gun (JP); Hideyuki Toma, Kodaira-shi (JP); Masatsugu Mukuge, Hiratsuka-shi (JP)

(21) Appl. No.: 13/080,534

(22) Filed: Apr. 5, 2011

(30) Foreign Application Priority Data
May 31, 2010 (JP) 2010-125132

(51) Int. Cl. G06T 15/00

(52) U.S. Cl. 345/419

(57) ABSTRACT

According to one embodiment, an image output control apparatus includes a detector and a controller. The detector is configured to detect a capability of an image display apparatus. The controller is configured to execute control to output one of a 2D image and a 3D image to the image display apparatus based on the capability detected by the detector.

### CROSS-REFERENCE TO RELATED APPLICATIONS

This application is based upon and claims the benefit of priority from Japanese Patent Application No. 2010-125132, filed May 31, 2010; the entire contents of which are incorporated herein by reference.

### FIELD

Embodiments described herein relate generally to an image output control apparatus and image output control method.

### BACKGROUND

In recent years, a demand for the display of three-dimensional (3D) images has arisen, and televisions and players compatible with 3D images are expected to become widespread in the future. As 3D image compatible devices, a device incorporating a 3D conversion function and a device not incorporating a 3D conversion function are available. The device incorporating a 3D conversion function can convert two-dimensional (2D) images (for example, broadcast or DVD content) into 3D images using the 3D conversion function and can output the 3D images. In contrast, the device not incorporating a 3D conversion function can output 3D images based on 3D image content.

In the case of televisions, those which have following capabilities are available:

(1) television not compatible with 3D images

(2) television not incorporating a 3D conversion function which is compatible with 3D images but does not incorporate any 3D conversion function for converting 2D images into 3D images

(3) television incorporating a 3D conversion function which is compatible with 3D images and incorporates a 3D conversion function for converting 2D images into 3D images

A player is assumed to be connected to these televisions having various capabilities.

However, it has not been sufficiently discussed how the player operates or what kind of control the player executes according to the capability of a connected partner (television).

For example, when a player compatible with 3D images is connected to a television incompatible with 3D images, even when that player compatible with 3D images outputs 3D images to the television incompatible with 3D images, the television incompatible with 3D images cannot display the 3D images.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an example of an image display system common to the first to fifth embodiments, and showing a first connection example;

FIG. 2 is a block diagram showing an example of an image display system common to the first and fourth embodiments, and showing a second connection example;

FIG. 3 is a block diagram showing an example of an image display system common to the first and fourth embodiments, and showing a third connection example;

FIG. 4 is a view showing a remote controller compatible with an image display apparatus shown in FIG. 3;

FIG. 5 is a view showing a remote controller compatible with an image playback apparatus shown in FIGS. 1, 2, and 3;

FIG. 6 is a view showing an alert display example of the first embodiment;

FIG. 7 is a view showing an alert display example of the second embodiment; and

FIG. 8 is a flowchart showing an example of image conversion control and information output control (for example, an alert) of the first and fourth embodiments.

### DETAILED DESCRIPTION

Various embodiments will be described hereinafter with reference to the accompanying drawings.

In general, according to one embodiment, an image output control apparatus includes a detector and a controller. The detector is configured to detect a capability of an image display apparatus. The controller is configured to execute control to output one of a 2D image and a 3D image to the image display apparatus based on the capability detected by the detector.

The first to fifth embodiments will be described hereinafter with reference to the drawings.

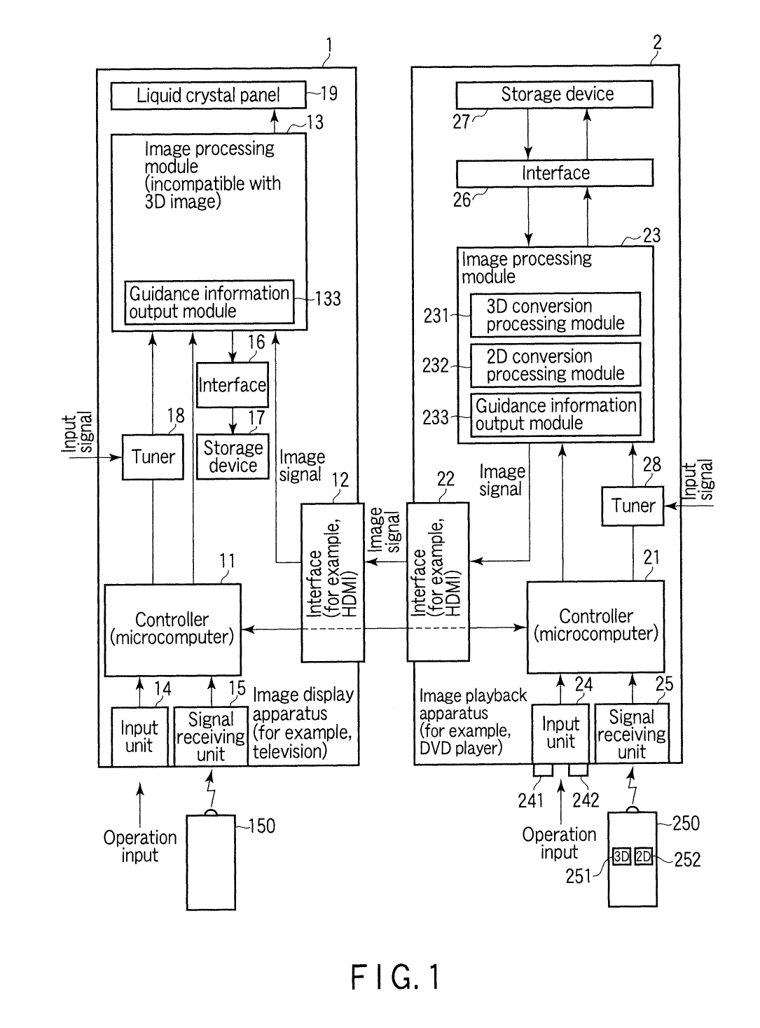

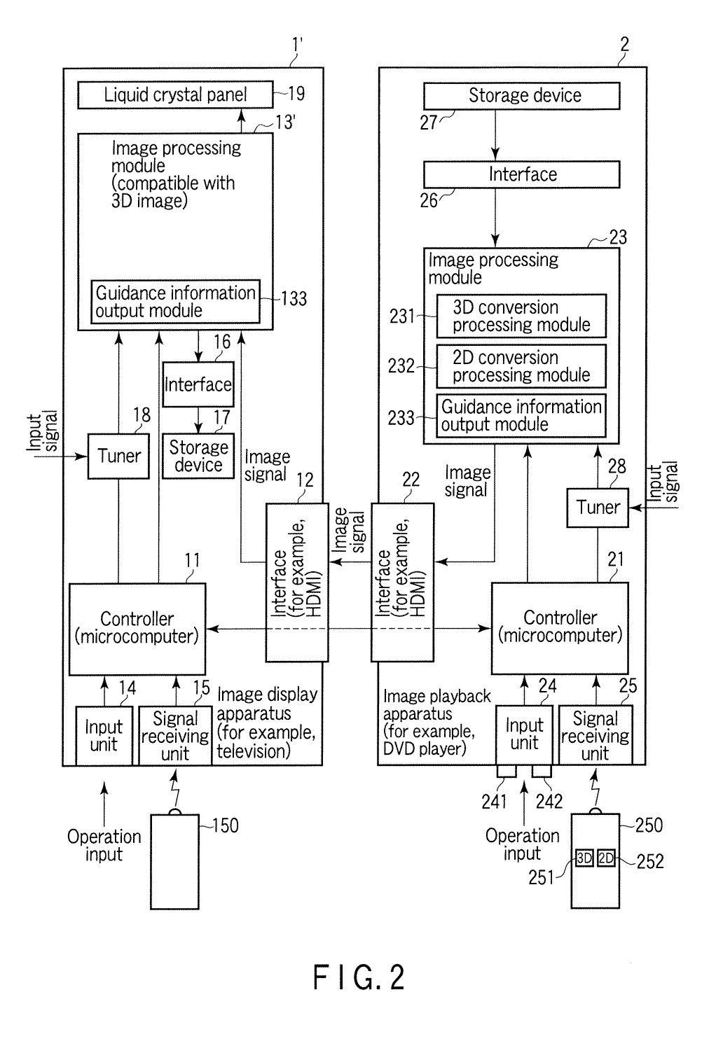

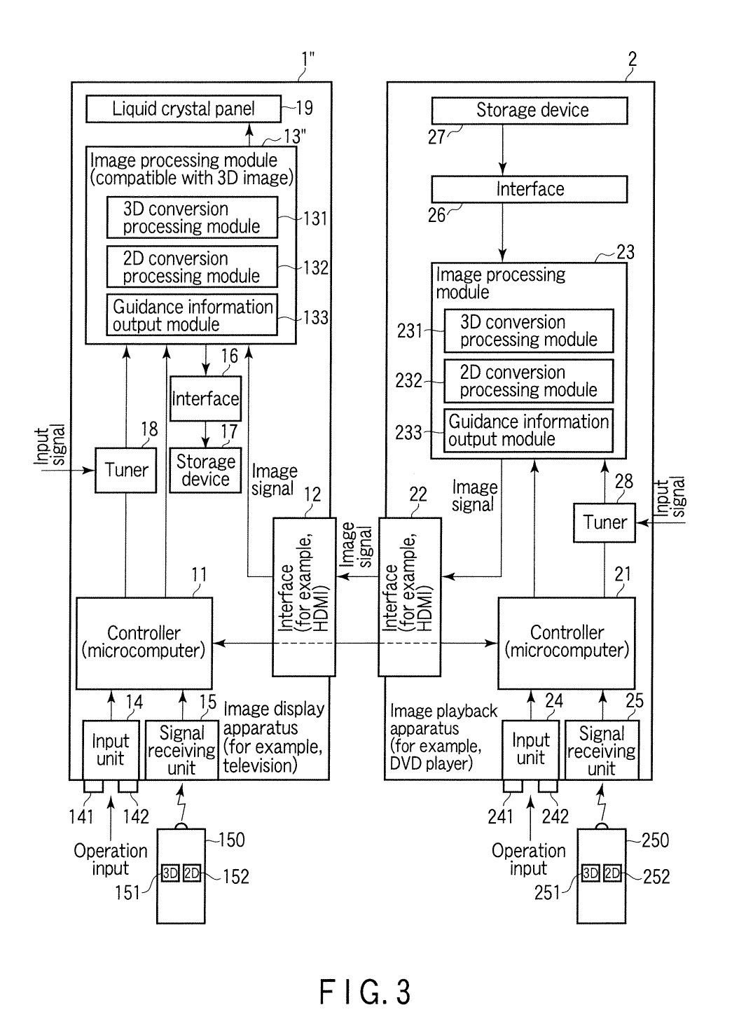

FIG. 1 is a block diagram showing an example of an image display system common to the first to fifth embodiments, and shows a connection example of an image display apparatus incompatible with 3D images and an image playback apparatus which is compatible with 3D images, and incorporates a 3D conversion function. FIG. 2 is a block diagram showing an example of an image display system common to the first and fourth embodiments, and shows a connection example of an image display apparatus which is compatible with 3D images and does not incorporate any 3D conversion function, and an image playback apparatus which is compatible with 3D images, and incorporates the 3D conversion function. FIG. 3 is an image display system common to the first and fourth embodiments, and shows a connection example of an image display apparatus which is compatible with 3D images and incorporates the 3D conversion function, and an image playback apparatus which is compatible with 3D images and incorporates the 3D conversion function. Note that the 3D conversion function of the image playback apparatus may be an optional function depending on the nature of respective embodiments.

An image display apparatus 1 (first image display apparatus) shown in FIG. 1 is incompatible with 3D images, and cannot display any 3D image. Image display apparatus 1 is, for example, a digital television receiver. On the other hand, an image display apparatus 2 is, for example, a DVD player, BD player, or set-top box.

Image display apparatus 1 includes a controller (control module) 11, interface 12, image processing module 13 (incompatible with 3D images), input unit 14, signal receiving unit 15, interface 16, storage device 17, tuner 18, and liquid crystal panel 19.

The image playback apparatus 2 includes a controller (control module) 21, interface 22, image processing module 23, input unit 24, signal receiving unit 25, interface 26, storage device 27, and tuner 28. The storage devices 17 and 27 include, for example, a DVD, BD, or HDD.

An image display apparatus 1′ (second image display apparatus) shown in FIG. 2 is compatible with 3D images, and can display 3D images. However, image display apparatus 1′ does not include any 3D conversion function for converting 2D images into 3D images. As in image display apparatus 1, image display apparatus 1′ is also, for example, a digital television receiver.

Image display apparatus 1′ includes the controller 11, the interface 12, an image processing module 13′, the input unit 14, the signal receiving unit 15, the interface 16, the storage device 17, the tuner 18, and the liquid crystal panel 19. Image processing module 13′ is configured to output 3D images, but it does not include any 3D conversion function.

Note that the image playback apparatus 2 shown in FIG. 2 is the same as that shown in FIG. 1.

An image display apparatus 1″ (third image display apparatus) shown in FIG. 3 is compatible with 3D images, and can display 3D images. In addition, image display apparatus 1″ includes a 3D conversion function for converting 2D images into 3D images. As in image display apparatus 1, image display apparatus 1″ is also, for example, a digital television receiver.

Image display apparatus 1″ includes the controller 11, the interface 12, an image processing module 13″, the input unit 14, the signal receiving unit 15, the interface 16, the storage device 17, the tuner 18, and the liquid crystal panel 19. Image processing module 13″ is configured to output 3D images, and includes a 3D conversion function (3D conversion processing module 131).

Note that the image playback apparatus 2 shown in FIG. 3 is the same as that shown in FIG. 1.

Image display apparatus 1″ and image playback apparatus 2 will be described first with reference to FIG. 3, and differences among the arrangements of image display apparatuses 1, 1′, and 1″ will then be explained.

Image display apparatus 1″ is configured to be connectable to the image playback apparatus 2 (that is, the interface 22) via the interface 12. In other words, the image playback apparatus 2 is configured to be connectable to image display apparatus 1″ (that is, the interface 12) via the interface 22.

The interfaces 12 and 22 are two-way communication units, and are interfaces which are compliant with, for example, the High-Definition Multimedia Interface (HDMI®) standard. The image playback apparatus 2 can transmit image and audio signals to image display apparatus 1″ via the interface 22, and image display apparatus 1″ can receive the image and audio signals transmitted from the image playback apparatus 2 via the interface 12.

Furthermore, the HDMI standard specifies a Consumer Electronics Control (HDMI-CEC) standard. By the HDMI-CEC functions of the interfaces 12 and 22, the controller 21 of the image playback apparatus 2 can transmit control signals to image display apparatus 1″ via the interface 22, and image display apparatus 1″ can receive the control signals transmitted from the image playback apparatus 2 via the interface 12. Then, the controller 11 of image display apparatus 1″ can control various operations based on the received control signals.

As described above, the interfaces 12 and 22 are configured to exchange control signals. With this configuration, when image display apparatus 1″ and image playback apparatus 2 are connected via the interfaces 12 and 22, the controller 11 of image display apparatus 1″ can notify the image playback apparatus 2 of the processing capability of image processing module 13″ via the interfaces 12 and 22, and the controller 21 of the image playback apparatus 2 can notify image display apparatus 1″ of the processing capability of image processing module 23 via the interfaces 12 and 22.

That is, when image display apparatus 1″ and image playback apparatus 2 are connected via the interfaces 12 and 22, the controller 11 of image display apparatus 1″ can detect connection of the image playback apparatus 2, and also the processing capability of image processing module 23. Also, the controller 21 of the image playback apparatus 2 can detect connection of image display apparatus 1″ and also the processing capability of image processing module 13″.

The input unit 14 includes a plurality of keys such as a 3D conversion key (2D→*3D conversion key) 141 and 2D conversion key (3D→*2D conversion key) 142. The 3D conversion key 141 is a key used to instruct to execute 3D conversion for converting an input image into a 3D image. For example, when the user presses the 3D conversion key 141, the input unit 14 issues a 3D conversion (3D conversion ON) instruction, and when he or she presses the 3D conversion key 141 again, the input unit 14 issues a 3D conversion cancel (3D conversion OFF) instruction. The 2D conversion key 142 is a key used to instruct to execute 2D conversion for converting input images into 2D images. When the user presses the 2D conversion key 142, the input unit 14 issues a 2D conversion (2D conversion ON) instruction, and when he or she presses the 2D conversion key 142 again, the input unit 14 issues a 2D conversion cancel (2D conversion OFF) instruction.

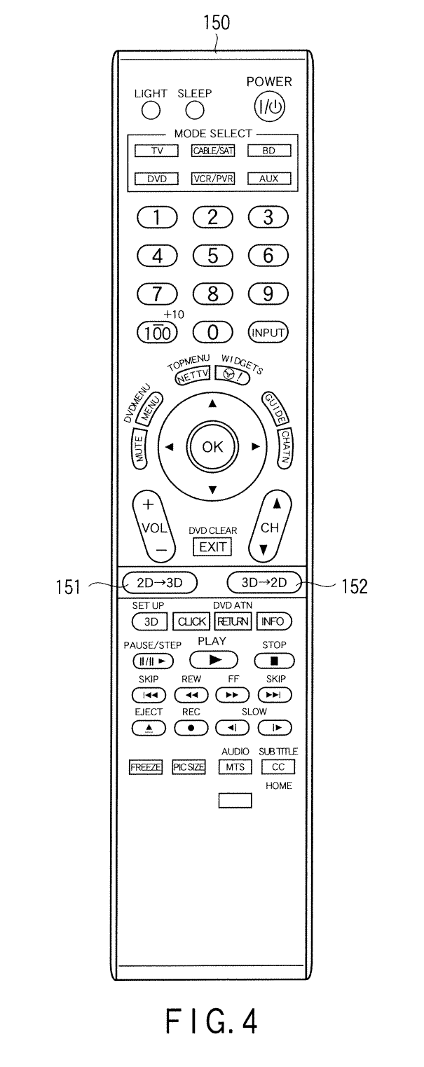

The signal receiving unit 15 receives a signal from a remote controller 150 shown in FIG. 4. As shown in FIG. 4, the remote controller 150 includes a plurality of keys such as a 3D conversion key (2D→3D conversion key) 151 and 2D conversion key (3D→2D conversion key) 152. The 3D conversion key 151 is substantially the same as the 3D conversion key 141, and a description of its function will not be given. Also, the 2D conversion key 152 is substantially the same as the 2D conversion key 142, and a description of its function will not be given.

Note that, for example, a single 2D/3D conversion key may be arranged in place of the 3D conversion key 141 and 2D conversion key 142. For example, when the user presses this 2D/3D conversion key once, the 2D/3D conversion key issues a 3D conversion instruction for converting an input image into a 3D image. When the user presses this 2D/3D conversion key twice successively, the 2D/3D conversion key issues a 2D conversion instruction for converting input images into 2D images.

Likewise, the input unit 24 includes a plurality of keys such as a 3D conversion key (2D→3D conversion key) 241 and 2D conversion key (3D→2D conversion key) 242. The 3D conversion key 241 is substantially the same as the 3D conversion key 141, and a description of its function will not be given. Also, the 2D conversion key 242 is substantially the same as the 2D conversion key 142, and a description of its function will not be given. Note that, for example, a single 2D/3D conversion key may be arranged in place of the 3D conversion key 241 and 2D conversion key 242.

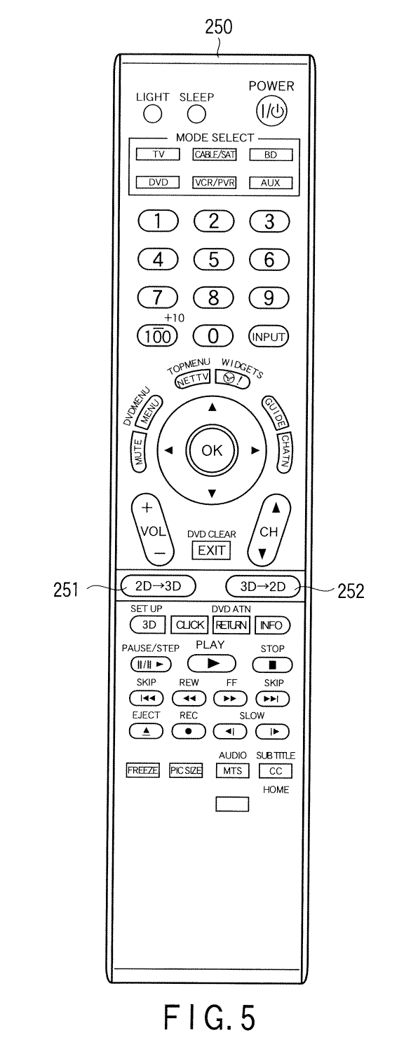

The signal receiving unit 25 receives a signal from a remote controller 250 shown in FIG. 5. As shown in FIG. 5, the remote controller 250 includes a plurality of keys such as a 3D conversion key (2D 3D conversion key) 251 and 2D conversion key (3D 2D conversion key) 252. The 3D conversion key 251 is substantially the same as the 3D conversion key 141, and a description of its function will not be given. Also, the 2D conversion key 252 is substantially the same as the 2D conversion key 142, and a description of its function will not be given.

Image processing module 23 includes a 3D conversion processing module 231, 2D conversion processing module 232, and guidance information output module (alert generation module) 233. The 3D conversion processing module 231 converts an original image signal (2D image signal) from the storage device 27 or tuner 28 into a 3D image signal, and outputs the 3D image signal. That is, the 3D conversion processing module 231 converts an original image signal (2D image signal) input via the interface 26 into a 3D image signal, and outputs the 3D image signal.

The 2D conversion processing module 232 converts an original image signal (3D image signal) from the storage device 27 or tuner 28 into a 2D image signal, and outputs the 2D image signal. That is, the 2D conversion processing module 232 converts an original image signal (3D image signal) input via the interface 26 into a 2D image signal, and outputs the 2D image signal. The guidance information output module 233 outputs guidance image signals corresponding to various kinds of guidance information.

Note that image processing module 23 can output a 2D-converted 2D image signal or 3D-converted 3D image signal, as described above, and can also output an original image signal (2D or 3D image signal) intact.

The interface 22 can output a 2D image signal, 3D image signal, or guidance image signal output from image processing module 23. Alternatively, the interface 22 can output a 2D composite image signal obtained by compositing a 2D image signal and guidance image signal, or a 3D composite image signal obtained by compositing a 3D image signal and guidance image signal. Alternatively, the interface 22 outputs an original image signal (2D or 3D image signal).

The interface 12 can receive the aforementioned 2D image signal, 3D image signal, or guidance image signal. Alternatively, the interface 12 can receive the aforementioned 2D or 3D composite image signal. Alternatively, the interface 12 can receive the original image signal (2D or 3D image signal).

Image processing module 13″ is an image processing module compatible with 3D images, and includes a 3D conversion processing module 131, 2D conversion processing module 132, and guidance information output module (alert generation module) 133. The 3D conversion processing module 131 converts an input image signal (2D image signal or 2D composite image signal) input via the interface 12 or tuner 18 into a 3D image signal, and outputs the 3D image signal. The 2D conversion processing module 132 converts an input image signal (3D image signal or 3D composite image signal) input via the interface 12 or tuner 18 into a 2D image signal, and outputs the 2D image signal. The guidance information output module 133 outputs guidance image signals corresponding to various kinds of guidance information (for example, an alert to be described later).

The liquid crystal panel 19 displays an image based on at least one image signal of a 2D image signal and guidance image signal output from image processing module 13″. For example, when image processing module 13″ composites a 2D image signal and guidance image signal and outputs a 2D composite image signal, the liquid crystal panel 19 can display a 2D image corresponding to the 2D image signal, and a guidance image corresponding to the guidance image signal to be superimposed on the displayed 2D image.

Alternatively, the liquid crystal panel 19 displays an image based on at least one image signal of a 3D image signal and guidance image signal output from image processing module 13″. For example, when image processing module 13″ composites a 3D image signal and guidance image signal and outputs a 3D composite image signal, the liquid crystal panel 19 can display a 3D image corresponding to the 3D image signal, and a guidance image corresponding to the guidance image signal to be superimposed on the displayed 3D image.

Note that 3D conversion processing and 2D conversion processing disclosed in, for example, Jpn. Pat. Appln. KOKAI Publication No. 2006-121553 can be applied to the 3D conversion processing in the 3D conversion processing modules 131 and 231 and the 2D conversion processing in the 2D conversion processing modules 132 and 232.

The image conversion control by image display apparatus 1″ will be described below.

As described above, the input unit 14 of image display apparatus 1″ includes the 3D conversion key (2D→3D conversion key) 141 and 2D conversion key (3D→2D conversion key) 142. The user who wants to display a 3D image presses, for example, the 3D conversion key 141. In response to the pressing of the 3D conversion key 141, the input unit 14 issues a 3D conversion instruction to the controller 11. The controller 11 determines based on various conditions whether or not the 3D conversion instruction is valid.

When it is determined that the 3D conversion instruction is valid, the controller 11 issues the 3D conversion instruction to image processing module 13″, and the 3D conversion processing module 131 executes the 3D conversion processing. For example, when the controller 11 detects that an image signal input via the interface 12 is a 3D image, it determines that the 3D conversion instruction is invalid.

The user who wants to display a 2D image for the reason that he or she does not want to use 3D spectacles presses, for example, the 2D conversion key 142. In response to the pressing of the 2D conversion key 142, the input unit 14 issues a 2D conversion instruction to the controller 11. The controller 11 determines based on various conditions whether or not the 2D conversion instruction is valid. When it is determined that the 2D conversion instruction is valid, the controller 11 issues the 2D conversion instruction to image processing module 13″, and the 2D conversion processing module 132 executes the 2D conversion processing. For example, when the controller 11 detects that an image signal input via the interface 12 is a 2D image, it determines that the 22 conversion instruction is invalid.

Note that the case has been described above

wherein the 3D conversion instruction is issued in response to the 3D conversion key 141, and the 2D conversion instruction is issued in response to the 2D conversion key 142. Also, the user can input a 3D or 2D conversion instruction via, for example, a menu screen displayed on the liquid crystal panel 19 of image display apparatus 1″. Also, the user can input a 3D or 2D conversion instruction via the 3D conversion key 151 or 2D conversion key 152 arranged on the remote controller 150.

The image conversion control by the image playback apparatus 2 will be described below.

As described above, the input unit 24 of the image playback apparatus 2 includes the 3D conversion key (2D→3D conversion key) 241 and 2D conversion key (3D→2D conversion key) 242. The user who wants to display a 3D image presses, for example, the 3D conversion key 241. In response to the pressing of the 3D conversion key 241, the input unit 24 issues a 3D conversion instruction to the controller 21. The controller 21 determines based on various conditions whether or not the 3D conversion instruction is valid. When it is determined that the 3D conversion instruction is valid, the controller 21 issues the 3D conversion instruction to image processing module 23, and the 3D conversion processing module 231 executes the 3D conversion processing. For example, when the controller 21 detects that an image signal input via the interface 26 is a 3D image, it determines that the 3D conversion instruction is invalid.

The user who wants to display a 2D image for the reason that he or she does not want to use 3D spectacles presses, for example, the 2D conversion key 242. In response to the pressing of the 2D conversion key 242, the input unit 24 issues a 2D conversion instruction to the controller 21. The controller 21 determines based on various conditions whether or not the 2D conversion instruction is valid. When it is determined that the 2D conversion instruction is valid, the controller 21 issues the 2D conversion instruction to image processing module 23, and the 2D conversion processing module 232 executes the 2D conversion processing. For example, when the controller 21 detects that an image signal input via the interface 26 is a 2D image, it determines that the 2D conversion instruction is invalid.

Note that the case has been described above wherein the 3D conversion instruction is issued in response to the 3D conversion key 241, and the 2D conversion instruction is issued in response to the 2D conversion key 242. Also, the user can input a 3D or 2D conversion instruction via, for example, a menu screen displayed on the liquid crystal panel 19 of image display apparatus 1″. Also, the user can input a 3D or 2D conversion instruction via the 3D conversion key 251 or 2D conversion key 252 arranged on the remote controller 250.

As described above, image display apparatus 1″ shown in FIG. 3 includes image processing module 13″, which is configured to output 3D images, and also includes the 3D conversion function (3D conversion processing module 131) for converting a 2D image into a 3D image. As shown in FIG. 3, for example, image processing module 13″ includes the guidance information output module (alert generation module) 133.

By contrast, image display apparatus 1′ shown in FIG. 2 includes image processing module 13′, which is configured to output a 3D image, but which does not include any 3D conversion function for converting a 2D image into a 3D image. As shown in FIG. 2, for example, image processing module 13′ includes the guidance information output module (alert generation module) 133.

Also, image display apparatus 1 shown in FIG. 1 includes image processing module 13, which is not configured to output any 3D image. As shown in FIG. 1, for example, image processing module 13 includes the guidance information output module (alert generation module) 133.

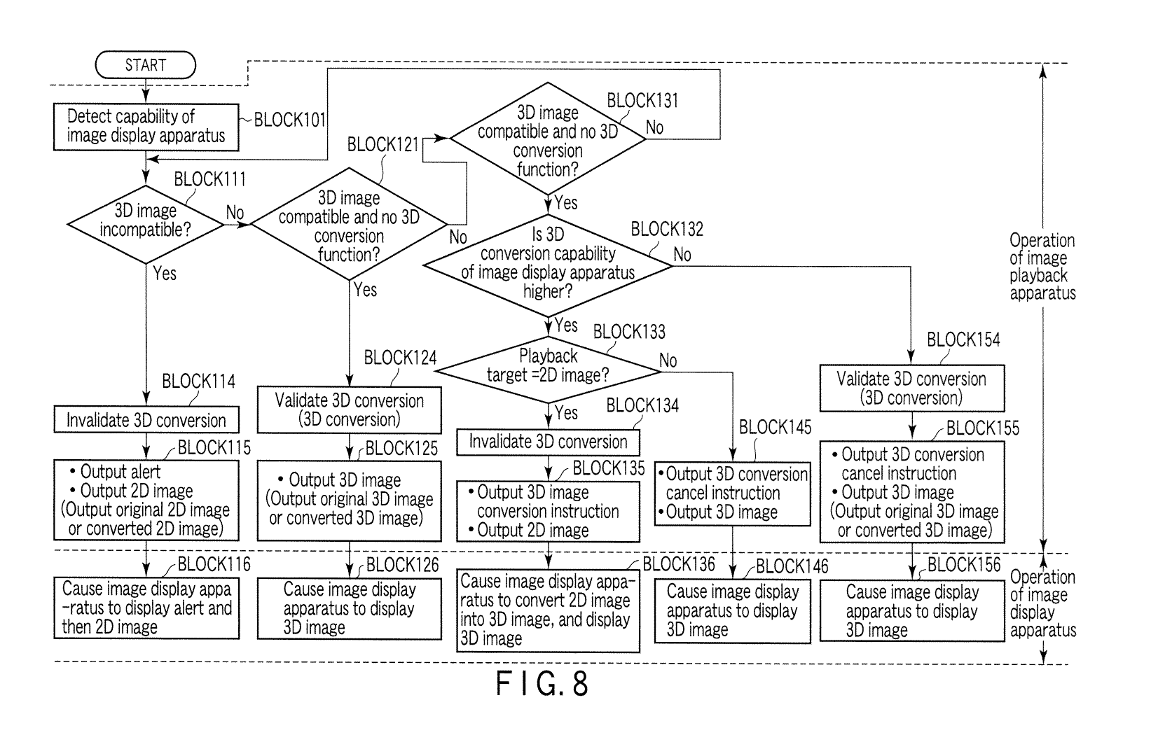

The information output control (for example, an alert) according to the first to third embodiments will be described below with reference to the connection examples shown in FIGS. 1, 2, and 3, and the flowchart shown in FIG. 8.

### First Embodiment

The first embodiment will explain the information output control (for example, an alert) by the image playback apparatus 2. As described above, the image playback apparatus 2 (image processing module 23) is compatible with 3D images, and is configured to output 2D and 3D images. In the first embodiment, the image playback apparatus 2 includes the 3D conversion processing module 231 as an indispensable component, and the 2D conversion processing module 232 as an optional component.

(1) Case of connection example shown in FIG. 1 (case in which video display apparatus 1 (television) side is incompatible with 3D images)

When image display apparatus 1 and image playback apparatus 2 are connected (when the image playback apparatus 2 recognizes image display apparatus 1) or in case of image playback processing by the image playback apparatus 2, the controller 21 of the image playback apparatus 2 detects (receives) the capability (3D image incompatibility) of the connected image display apparatus 1 via the interface 22 (BLOCK 101).

The controller 21 of the image playback apparatus 2 controls to generate (or select) and output suitable information (an alert message indicating 3D image incompatibility) to image display apparatus 1 based on the detected capability (3D image incompatibility) (YES in BLOCK 111). In response to this, the guidance information output module 233 of the image playback apparatus 2 generates (or selects) and outputs an alert message to image display apparatus 1 via the interface 22 (BLOCK 115). Furthermore, the controller 21 can also output display control information required to execute control to display this alert message.

Image display apparatus 1 receives the alert message via the interface 12, the guidance information output module 133 of image display apparatus 1 controls to output the received alert message, and the liquid crystal panel 19 displays the alert message (BLOCK 116). Alternatively, image display apparatus 1 receives the aforementioned display control information and alert message via the interface 12, the guidance information output module 133 of image display apparatus 1 controls to output the received alert message based on the display control information, and the liquid crystal panel 19 displays the alert message (BLOCK 116).

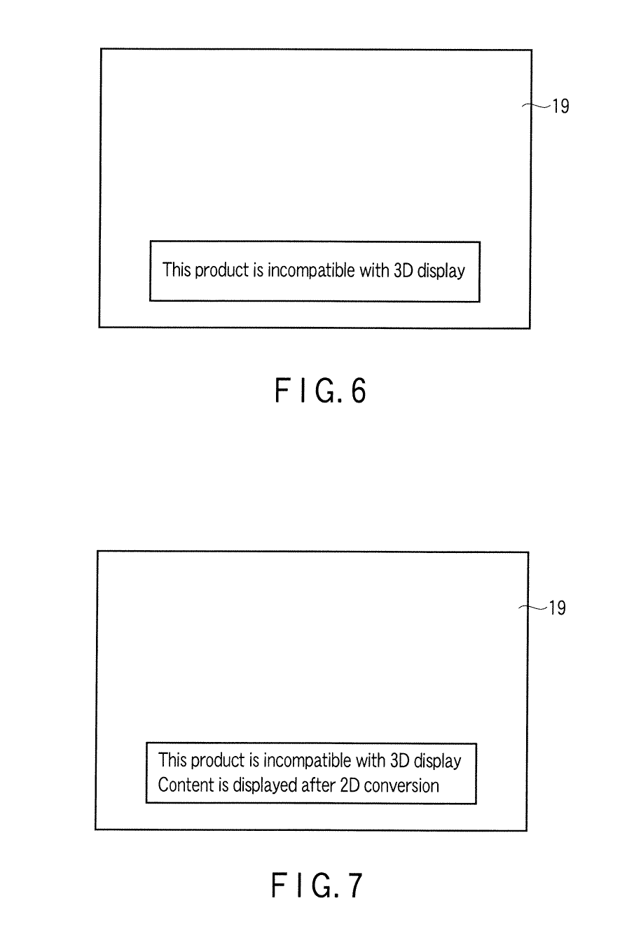

That is, in response to connection of the 3D image incompatible image display apparatus 1 and 3D image compatible image playback apparatus 2, the liquid crystal panel 19 of the 3D image incompatible image display apparatus 1 displays an alert message “This product is incompatible with 3D display”, as shown in, for example, FIG. 6, under the control of the image playback apparatus 2. With this message, the user can easily and surely recognize that “image display apparatus 1 (television) is incompatible with any 3D image” and “a 3D image cannot be displayed even when the 3D image compatible image playback apparatus 2 (player) is connected”.

Furthermore, if the controller 21 detects the capability (3D image incompatibility) of image display apparatus 1 (YES in BLOCK 111), even if a 3D conversion instruction is issued by, for example, the 3D conversion key 241, the controller 21 determines that this 3D conversion instruction is invalid (BLOCK 114). Thus, when the controller 21 detects the capability (3D image incompatibility) of image display apparatus 1, the video processing module 23 outputs a 2D image (original 2D image) to image display apparatus 1 via the interface 22 (BLOCK 115).

Image display apparatus 1 receives the 2D image via the interface 12, and the liquid crystal panel 19 displays the 2D image (BLOCK 116).

(2) Case of connection example shown in FIG. 2 (case in which video display apparatus 1′ (television) side is compatible with 3D images, but it does not include any 3D conversion function)

When image display apparatus 1′ and image playback apparatus 2 are connected (when the image playback apparatus 2 recognizes image display apparatus 1′) or in case of the image playback processing by the image playback apparatus 2, the controller 21 of the image playback apparatus 2 detects (receives) the capability (3D image compatibility and 3D conversion NG) of the connected image display apparatus 1′ via the interface 22 (BLOCK 101).

The controller 21 of the image playback apparatus 2 does not execute control to output the aforementioned alert message to image display apparatus 1′ based on the detected capability (3D image compatibility and 3D conversion NG) (YES in BLOCK 121). That is, the liquid crystal panel 19 of image display apparatus 1′ does not display the aforementioned alert message.

Furthermore, if the controller 21 detects the capability (3D image compatibility and 3D conversion NG) of image display apparatus 1′ (YES in BLOCK 121), and if a 3D conversion instruction is issued by, for example, the 3D conversion key 241 (or if the 3D conversion instruction has already been issued), the controller 21 determines that this 3D conversion instruction is valid (BLOCK 124). Alternatively, the controller 21 determines that 3D conversion is valid without any 3D conversion instruction (BLOCK 124). Thus, when the controller 21 detects the capability (3D image compatibility and 3D conversion NG) of image display apparatus 1′ and detects that an image signal input to image processing module 23 is a 2D image, the 3D conversion processing module 231 converts the 2D image input via the interface 26 into a 3D image, and image processing module 23 outputs the 3D image to image display apparatus 1′ via the interface 22 (BLOCK 125).

When the controller 21 detects the capability (3D image compatibility and 3D conversion NG) of image display apparatus 1′ and an input of a 3D image to image processing module 23, if a 3D conversion instruction is input by, for example, the 3D conversion key 241, the controller 21 determines that this 3D conversion instruction is invalid. As a result, the 3D conversion processing is skipped, but image processing module 23 outputs an original 3D image to image display apparatus 1′ via the interface 22 (BLOCK 125).

Image display apparatus 1′ receives the 3D image via the interface 12, and the liquid crystal panel 19 displays the 3D image (BLOCK 126).

(3) Case of connection example shown in FIG. 3 (case in which video display apparatus 1″ (television) side is compatible with 3D images and includes 3D conversion function)

When image display apparatus 1″ and image playback apparatus 2 are connected (when the image playback apparatus 2 recognizes image display apparatus 1″) or in case of the image playback apparatus by the image playback apparatus 2, the controller 21 of the image playback apparatus 2 detects (receives) the capability (3D image compatibility and 3D conversion OK) of the connected image display apparatus 1″ via the interface 22 (BLOCK 101).

The controller 21 of the image playback apparatus 2 does not execute control to output the aforementioned alert message to image display apparatus 1″ based on the detected capability (3D image compatibility and 3D conversion OK) (YES in BLOCK 131). That is, the liquid crystal panel 19 of image display apparatus 1″ does not display the aforementioned alert message.

Furthermore, when the controller 21 detects the capability (3D image compatibility and 3D conversion OK) of image display apparatus 1″, it selects, for example, a first priority mode that prioritizes the 3D conversion function of the image playback apparatus 2.

As a result, when a 3D conversion instruction is input by, for example, the 3D conversion key 241 (or the 3D conversion instruction has already been issued), the controller 21 determines that this 3D conversion instruction is valid. Alternatively, the controller 21 determines that the 3D conversion is valid if no 3D conversion instruction is input. Hence, when the controller 21 detects the capability (3D image compatibility and 3D conversion OK) of image display apparatus 1″, and detects that an image signal input to image processing module 23 is a 2D image, the 3D conversion processing module 231 converts a 2D image input via the interface 26 into a 3D image, and image processing module 23 outputs the 3D image to image display apparatus 1″ via the interface 22.

Note that in this case, the controller 21 may output a 3D conversion stop instruction, 3D conversion inhibition instruction, and 3D conversion cancel instruction to image display apparatus 1″ via the interface 22 (that is, the controller 21 may transmit a 3D conversion stop command, 3D conversion inhibition command, and 3D conversion cancel command).

Alternatively, when the controller 21 detects the capability (3D image compatibility and 3D conversion OK) of image display apparatus 1″, as described above, it selects, for example, a second priority mode that prioritizes the 3D conversion function of image display apparatus 1″.

As a result, even when a 3D conversion instruction is input by, for example, the 3D conversion key 241 (or when the 3D conversion instruction has already been issued), the controller 21 determines that this 3D conversion instruction is invalid. Hence, when the controller 21 detects the capability (3D image compatibility and 3D conversion OK) of image display apparatus 1″ and also detects that an image signal input to image processing module 23 is a 2D image, the controller 21 instructs image display apparatus 1″ to execute the 3D conversion (it transmits a 3D conversion command) via the interface 22, and image processing module 23 outputs the 2D image to image display apparatus 1″ via the interface 22.

Then, image display apparatus 1″ receives the 3D conversion instruction and 2D image, the 3D conversion processing module 131 converts the 2D image into a 3D image based on the 3D conversion instruction, and the liquid crystal panel 19 displays the converted 3D image.

Alternatively, when the controller 21 detects the capability (3D image compatibility and 3D conversion OK) of image display apparatus 1″, as described above, it selects a third priority mode that compares a 3D conversion capability (a) of image display apparatus 1″ with a 3D conversion capability (b) of the image playback apparatus 2, and preferentially selects one of the 3D conversion capabilities (a) and (b) based on the comparison result.

As a result, if the controller 21 determines that the 3D conversion capability (a) of image display apparatus 1″ is higher than the 3D conversion capability (b) of the image playback apparatus 2 (YES in BLOCK 132), and detects that an image signal input to image processing module 23 is a 2D image (YES in BLOCK 133), the controller 21 prioritizes the 3D conversion capability of image display apparatus 1″.

In this case, even when a 3D conversion instruction is input by, for example, the 3D conversion key 241 (or even when the 3D conversion instruction has already been issued), the controller 21 determines that this 3D conversion instruction is invalid. Hence, the controller 21 instructs image display apparatus 1″ to execute the 3D conversion (it transmits a 3D conversion command) via the interface 22, and image processing module 23 outputs the 2D image to image display apparatus 1″ via the interface 22 (BLOCK 135).

Then, image display apparatus 1″ receives the 3D conversion instruction and 2D image, the 3D conversion processing module 131 converts the 2D image into a 3D image based on the 3D conversion instruction, and the liquid crystal panel 19 displays the converted 3D image (BLOCK 136).

Note that even when the controller 21 determines that the 3D conversion capability (a) of image display apparatus 1″ is higher than the 3D conversion capability (b) of the image playback apparatus 2 (YES in BLOCK 132), if it detects that an image signal input to image processing module 23 is a 3D image (NO in BLOCK 133), image processing module 23 outputs the 3D image (BLOCK 145). Furthermore, the controller 21 may issue a 3D conversion stop instruction to image display apparatus 1″ via the interface 22 (it may transmit a 3D conversion stop command).

As a result, image display apparatus 1″ receives the 3D image, and the liquid crystal panel 19 displays the 3D image (BLOCK 146). Furthermore, when image display apparatus 1″ receives the 3D conversion stop instruction, and the 3D conversion processing of the 3D conversion processing module 131 is executed or its conversion processing is set, the controller 11 stops or cancels the 3D conversion processing.

When the controller 21 determines that the 3D conversion capability (a) of image display apparatus 1″ is lower than the 3D conversion capability (b) of the image playback apparatus 2 (NO in BLOCK 132), and detects that an image signal input to image processing module 23 is a 2D image, if a 3D conversion instruction is input by, for example, the 3D conversion key 241 (or the 3D conversion instruction has already been issued), the controller 21 determines that this 3D conversion instruction is valid (BLOCK 154). Alternatively, the controller 21 determines that the 3D conversion is valid without any 3D conversion instruction (BLOCK 154). Hence, the 3D conversion processing module 231 converts the 2D image input via the interface 26 into a 3D image, and image processing module 23 outputs the 3D image to image display apparatus 1″ via the interface (BLOCK 155). Note that in this case, the controller 21 may issue a 3D conversion stop instruction to image display apparatus 1″ via the interface 22 (or it may transmit a 3D conversion stop command) (BLOCK 155).

As a result, image display apparatus 1″ receives the 3D image, and the liquid crystal panel 19 displays the 3D image (BLOCK 156). Furthermore, when image display apparatus 1″ receives, for example, the 3D conversion stop instruction, and the 3D conversion processing of the 3D conversion processing module 131 is executed or its conversion processing is set, the controller 11 stops or cancels the 3D conversion processing.

Note that the controller 21 may be set with one of the first, second, and third priority modes as an initial value, and the user may change the priority mode via, for example, the input unit 24 or remote controller 250.

With the above processing, a situation that a 3D image output from the image playback apparatus 2 unwantedly undergoes another 3D conversion in image display apparatus 1″ (image breakdown) can be automatically prevented. The user need not change 3D conversion settings of both image display apparatus 1″ and image playback apparatus 2 so as to prevent such image breakdown.

### Second Embodiment

The second embodiment will explain image conversion control and information output control (for example, an alert) by the image playback apparatus 2. As described above, the image playback apparatus 2 (image processing module 23) is compatible with 3D images, and is configured to output 2D and 3D images. In the second embodiment, the image playback apparatus 2 includes the 3D conversion processing module 231 and 2D conversion processing module 232 as indispensable components.

When image display apparatus 1 and image playback apparatus 2 are connected (when the image playback apparatus 2 recognizes image display apparatus 1), as shown in FIG. 1, or in case of image playback processing by the image playback apparatus 2, the controller 21 of the image playback apparatus 2 detects (receives) the capability (3D image incompatibility) of the connected image display apparatus 1 via the interface 22.

The controller 21 of the image playback apparatus 2 controls to generate (or select) and output a 2D image and suitable information (information indicating 3D image incompatibility, and an alert message indicating that a 2D image is displayed) to image display apparatus 1 based on the detected capability (3D image incompatibility). In response to this, the guidance information output module 233 of the image playback apparatus 2 generates (or selects) and outputs an alert message to image display apparatus 1 via the interface 22, and image processing module 23 outputs a 2D image.

For example, when the controller 21 detects that an image signal input to image processing module 23 is a 2D image, the guidance information output module 233 generates (or selects) and outputs a first alert message (information indicating 3D image incompatibility, and an alert message indicating that an original 2D image is displayed intact) to image display apparatus 1 via the interface 22. Furthermore, image processing module 23 outputs the 2D image intact via the interface 22 under the control of the controller 21.

In response to this, image display apparatus 1 receives the first alert message and then the 2D image via the interface 12, and image processing module 13 outputs the first alert message and then the 2D image. Alternatively, image processing module 13 composites the first alert message on the 2D image, and outputs a composite image signal for a predetermined period. After that, image processing module 13 outputs the 2D image by excluding the first alert message. Then, the liquid crystal panel 19 displays the first alert message, and then the 2D image. Alternatively, the liquid crystal panel 19 displays the first alert message together with the 2D image for the predetermined period, and then displays the 2D image alone.

When the controller 21 detects that an image signal input to image processing module 23 is a 3D image, the guidance information output module 233 generates (or selects) and outputs a second alert message (information indicating 3D image incompatibility and an alert message indicating that a 2D image converted from a 3D image is displayed) to image display apparatus 1 via the interface 22. Furthermore, the 2D conversion processing module 232 converts the 3D image into a 2D image, and outputs the converted 2D image via the interface 22 under the control of the controller 21.

In response to this, image display apparatus 1 receives the second alert message and then the converted 2D image via the interface 12, and image processing module 13 outputs the second alert message and then the converted 2D image. Alternatively, image processing module 13 composites the second alert message on the converted 2D image, and outputs a composite image signal for a predetermined period. After that, image processing module 13 outputs the converted 2D image by excluding the second alert message. Then, the liquid crystal panel 19 displays the second alert message and then the converted 2D image. Alternatively, the liquid crystal panel 19 displays the second alert message together with the converted 2D image for the predetermined period, and then displays the converted 2D image alone. FIG. 7 shows an example of the second alert message. As shown in FIG. 7, the second alert message “This product is incompatible with 3D display. Content is displayed after 2D conversion.” is displayed.

That is, in response to connection between the 3D image incompatible image display apparatus 1 and 3D image compatible image playback apparatus 2, the liquid crystal control panel 19 of the 3D image incompatible image display apparatus 1 displays, for example, an alert message “This product is incompatible with 3D display. A 2D image is displayed intact.” or “This product is incompatible with 3D display. A converted 2D image is displayed.” under the control of the image playback apparatus 2. Then, the user can easily and surely recognizes that “image display apparatus 1 (television) is incompatible with any 3D image”, “a 3D image cannot be displayed even when the 3D image compatible image playback apparatus 2 (player) is connected”, and “a 3D image is converted into a 2D image”. That is, the user can view 2D or 3D image content as a 2D image using image display apparatus 1 without regarding whether the original image content is a 3D or 2D image. In addition, the user need not input any 2D conversion instruction or 3D conversion instruction cancel instruction to the image playback apparatus 2.

### Third Embodiment

The third embodiment will explain information output control (for example, an alert) by image display apparatus 1. As described above, image display apparatus 1 (image processing module 13) is incompatible with a 3D image, and cannot output any 3D image.

When image display apparatus 1 and image playback apparatus 2 are connected (when the image playback apparatus 2 recognizes image display apparatus 1) or in case of image playback processing by the image playback apparatus 2, the controller 11 of image display apparatus 1 detects (receives) the capability (3D image compatibility) of the connected image playback apparatus 2 via the interface 12.

The controller 11 of image display apparatus 1 controls the guidance information output module 133 to generate (or select) and output suitable information (an alert message indicating 3D image incompatibility) based on the detected capability (3D image compatibility). In response to this, the guidance information output module 133 generates (or selects) and outputs an alert message to the liquid crystal panel 19, and the liquid crystal panel 19 displays the alert message.

That is, in response to connection of the 3D image incompatible image display apparatus 1 and 3D image compatible image playback apparatus 2, the liquid crystal panel 19 displays an alert message “This product is incompatible with 3D display”, as shown in, for example, FIG. 6 under the control of image display apparatus 1. Then, the user can easily and surely recognizes that “image display apparatus 1 (television) is incompatible with any 3D image”, and “a 3D image cannot be displayed even when the 3D image compatible image playback apparatus 2 (player) is connected”.

According to the aforementioned first or second embodiment, in response to connection of the 3D image incompatible image display apparatus 1 and 3D image compatible image playback apparatus 2, the image playback apparatus 2 generates (selects) and outputs an alert message indicating the 3D image incompatible image display apparatus 1 (television). As a result, even when image display apparatus 1 does not have any component for generating (selecting) and outputting the aforementioned alert message, image display apparatus 1 can display the aforementioned alert message.

Also, according to the third embodiment, in response to connection of the 3D image incompatible image display apparatus 1 and 3D image compatible image playback apparatus 2, image display apparatus 1 generates (selects) and outputs the alert message indicating 3D image incompatibility. As a result, even when the image playback apparatus 2 does not have any component for generating (selecting) and outputting the aforementioned alert message, image display apparatus 1 can display the aforementioned alert message in response to connection with the 3D image compatible image playback apparatus 2.

Then, the user can easily and surely recognize that “image display apparatus 1 (television) is incompatible with any 3D image”, and “a 3D image cannot be displayed even when the 3D image compatible image playback apparatus 2 (player) is connected”.

Image conversion control according to the fourth and fifth embodiment will be described below with reference to the connection examples shown in FIGS. 1, 2, and 3.

### Fourth Embodiment

The fourth embodiment will explain the image conversion control by the image playback apparatus 2. As described above, the image playback apparatus 2 (image processing module 23) is compatible with 3D images, and is configured to output 2D and 3D images. In the fourth embodiment, the image playback apparatus 2 includes the 3D conversion processing module 231 as an indispensable component, and the 2D conversion processing module 232 as an optional component.

(1) Case of connection example shown in FIG. 1 (case in which video display apparatus 1 (television) side is incompatible with 3D images)

Basically, as described in (1) of the first embodiment, when the controller 21 of the image playback apparatus 2 detects the capability (3D image incompatibility) of image display apparatus 1, even when a 3D conversion instruction is input by, for example, the 3D conversion key 241, the controller 21 determines that this 3D conversion instruction is invalid. Hence, when the controller 21 detects the capability (3D image incompatibility) of image display apparatus 1, image processing module 23 outputs a 2D image to image display apparatus 1 via the interface 22.

(2) Case of connection example shown in FIG. 2 (case in which video display apparatus 1′ (television) side is compatible with 3D images, but it does not include any 3D conversion function)

Basically, as described in (2) of the first embodiment, when the controller 21 of the image playback apparatus 2 detects the capability (3D image compatibility and 3D conversion NG) of image display apparatus 1′, and also an input of a 2D image to image processing module 23, if a 3D conversion instruction is input by, for example, the 3D conversion key 241, the controller 21 determines that this 3D conversion instruction is valid. Alternatively, the controller 21 determines that the 3D conversion is valid without any 3D conversion instruction. Hence, when the controller 21 detects the capability (3D image compatibility and 3D conversion NG) of image display apparatus 1′, and that an image signal input to image processing module 23 is a 2D image, the 3D conversion processing module 231 converts the 2D image input via the interface 26 into a 3D image, and image processing module 23 outputs the 3D image to image display apparatus 1′ via the interface 22.

When the controller 21 detects the capability (3D image compatibility and 3D conversion NG) of image display apparatus 1′, and also an input of a 3D image to image processing module 23, if a 3D conversion instruction is input by, for example, the 3D conversion key 241, the controller 21 determines that this 3D conversion is invalid. As a result, the 3D conversion processing is skipped, but image processing module 23 outputs an original 3D image to image display apparatus via the interface 22.

(3) Case of connection example shown in FIG. 3 (case in which video display apparatus 1″ (television) side is compatible with 3D images and includes 3D conversion function)

Basically, as described in (3) of the first embodiment, when the controller 21 of the image playback apparatus 2 detects the capability (3D image compatibility and 3D conversion OK) of image display apparatus 1″, it selects a first priority mode that prioritizes the 3D conversion function of the image playback apparatus 2. Then, when a 3D conversion instruction is input by, for example, the 3D conversion key 241 (or when the 3D conversion instruction has already been input), the controller 21 determines that this 3D conversion instruction is valid.

Alternatively, the controller 21 determines that the 3D conversion is valid if no 3D conversion instruction is input. Hence, when the controller 21 detects the capability (3D image compatibility and 3D conversion OK) of image display apparatus 1″, and detects that an image signal input to image processing module 23 is a 2D image, the 3D conversion processing module 231 converts the 2D image input via the interface 26 into a 3D image, and image processing module 23 outputs the 3D image to image display apparatus 1″ via the interface 22.

Alternatively, as described in (3) of the first embodiment, when the controller 21 of the image playback apparatus 2 detects the capability (3D image compatibility and 3D conversion OK) of image display apparatus 1″, it selects, for example, a second priority mode that prioritizes the 3D conversion function of image display apparatus 1. As a result, even when a 3D conversion instruction is input by, for example, the 3D conversion key 241 (or even when the 3D conversion instruction has already been input), the controller 21 determines that this 3D conversion instruction is invalid. Hence, when the controller 21 detects the capability (3D image compatibility and 3D conversion OK) of image display apparatus 1″, and detects that an image signal input to image processing module 23 is a 2D image, it instructs image display apparatus 1″ to execute the 3D conversion via the interface 22 (it transmits a 3D conversion command), and image processing module 23 outputs the 2D image to image display apparatus 1″ via the interface 22.

Alternatively, as described in (3) of the first embodiment, when the controller 21 of the image playback apparatus 2 detects the capability (3D image compatible and 3D conversion OK) of image display apparatus 1″, it selects a third priority mode that compares a 3D conversion capability (a) of image display apparatus 1″ with a 3D conversion capability (b) of the image playback apparatus 2, and preferentially selects one of the 3D conversion capabilities (a) and (b) based on the comparison result.

Then, when the controller 21 determines that the 3D conversion capability (a) of image display apparatus 1″ is higher than the 3D conversion capability (b) of the image playback apparatus 2, and detects that an image signal input to image processing module 23 is a 2D image, it preferentially uses the 3D conversion capability (a) of image display apparatus 1″. In this case, for example, even when a 3D conversion instruction is input by, for example, the 3D conversion key 241 (or when the 3D conversion instruction has already been input), the controller 21 determines that this 3D conversion instruction is invalid. Hence, the controller 21 instructs image display apparatus 1″ to execute the 3D conversion via the interface 22 (it transmits a 3D conversion command), and image processing module 23 outputs the 2D image to image display apparatus 1″ via the interface 22.

On the other hand, when the controller 21 determines that the 3D conversion capability (a) of image display apparatus 1″ is lower than the 3D conversion capability (b) of the image playback apparatus 2, and detects that an image signal input to image processing module 23 is a 2D image, if a 3D conversion instruction is input by, for example, the 3D conversion key 241 (or the 3D conversion instruction has already been issued), the controller 21 determines that this 3D conversion instruction is valid. Alternatively, the controller 21 determines that the 3D conversion is valid without any 3D conversion instruction. Hence, the 3D conversion processing module 231 converts the 2D image input via the interface 26 into a 3D image, and image processing module 23 outputs the 3D image to image display apparatus 1″ via the interface 22.

Note that the controller 21 may be set with one of the first, second, and third priority modes as an initial value, and the user may change the priority mode via, for example, the input unit 24 or remote controller 250.

With the above processing, a situation that a 3D image output from the image playback apparatus 2 unwantedly undergoes another 3D conversion in image display apparatus 1″ (image breakdown) can be automatically prevented. The user need not change 3D conversion settings of both image display apparatus 1″ and image playback apparatus 2 so as to prevent such image breakdown

### Fifth Embodiment

The fifth embodiment will explain the image conversion control by the image playback apparatus 2.

As described above, the image playback apparatus 2 (image processing module 23) is compatible with 3D images, and is configured to output 2D and 3D images. In the fifth embodiment, the image playback apparatus 2 includes the 3D conversion processing module 231 and 2D conversion processing module 232 as indispensable components.

Basically, as described in the second embodiment, when the controller 21 of the image playback apparatus 2 detects the capability (3D image incompatibility) of the connected image display apparatus 1, and also detects that an image signal input to image processing module 23 is a 3D image, the controller 21 instructs to execute 2D conversion. Then, the 2D conversion processing module 232 converts the 3D image into a 2D image, and outputs the converted 2D image via the interface 22. Image display apparatus 1 receives the converted 2D image via the interface 12, and the liquid crystal panel 19 displays the converted 2D image.

That is, in response to connection between the 3D image incompatible image display apparatus 1 and 3D image compatible image playback apparatus 2, the image playback apparatus 2 automatically converts a 3D image into a 2D image, and outputs the converted 2D image to image display apparatus 1. Hence, the user can easily view an optimal image without regarding whether content to be played back is a 3D or 2D image, and without inputting any 2D conversion instruction or 3D conversion instruction cancel instruction to the image playback apparatus 2.

As described above, according to the first to fifth embodiments, a cooperation function of a 3D image compatible device and 3D image incompatible device suited to the user can be provided.

Note that a 3D image described in the aforementioned first to fifth embodiments is displayed by, for example, a time-division method. The time-division method is a method which displays or presents a 3D image by combining active liquid crystal shutter spectacles and a high-speed driving display.

That is, image display apparatuses 1′ and 1″ can display a 3D image compatible with the time-division method. That is, each of image processing modules 13′ and 13″ outputs images for the right and left eyes while switching them for each frame, and the liquid crystal panel 19 (high-speed driving display) displays the images for the right and left eyes while switching them for each frame in response to this.

The user can view a 3D image by wearing the active liquid crystal shutter spectacles. That is, the liquid crystal shutter spectacles alternately closes shutters for the right and left eyes in response to switching of the images for the right and left eyes for each frame, and present the image for the right eye to the right eye, and that for the left eye to the left eye.

The 3D image display based on the time-division method has been exemplified. However, other 3D display methods may be adopted. For example, a 3D image display method that allows the user to view a 3D image with the naked eyes may be adopted.

The various modules of the embodiments described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image output control apparatus comprising:
a detector configured to detect a capability of an image display apparatus; and
a controller configured to execute control to output one of a 2D image and a 3D image to the image display apparatus based on the capability detected by the detector.

2. The apparatus of claim 1, further comprising:
a determination module configured to determine based on the capability detected by the detector whether or not 3D conversion required to convert the 2D image into the 3D image is valid.

3. The apparatus of claim 2, further comprising:
a conversion module configured to convert the 2D image into the 3D image in response to validity determination of the 3D conversion by the determination module; and
an output module configured to output the 3D image to the image display apparatus in response to validity determination of the 3D conversion by the determination module.

4. The apparatus of claim 2, wherein the output module is configured to output the 2D image to the image display apparatus in response to invalidity determination of the 3D conversion by the determination module.

5. The apparatus of claim 1, wherein the detector is configured to detect a connection of a 3D image incompatible first image display apparatus, and
the controller is configured to execute control to output the 2D image to the first image display apparatus in response to the detection of the connection of the first image display apparatus.

6. The apparatus of claim 1, wherein the detector is configured to detect a connection of a 3D image compatible second image display apparatus, and
the controller is configured to execute control to output the 3D image to the second image display apparatus in response to the detection of the connection of the second image display apparatus.

7. The apparatus of claim 1, wherein the detector is configured to detect a connection of a second image display apparatus which is configured not to convert the 2D image into the 3D image, and is configured to output the 3D image, and
the controller is configured to execute control to output the 3D image to the second image display apparatus in response to the detection of the connection of the second image display apparatus.

8. The apparatus of claim 1, wherein the detector is configured to detect a connection of a third image display apparatus which is configured to convert the 2D image into the 3D image, and is configured to output the 3D image, and
the controller is configured to execute control to output the 2D image to the third image display apparatus in response to the detection of the connection of the third image display apparatus.

9. The apparatus of claim 1, wherein the detector is configured to detect a connection of a third image display apparatus which is configured to convert the 2D image into the 3D image, and is configured to output the 3D image, and to detect a 3D conversion capability of the third image display apparatus, and
the controller is configured to execute control to output the 2D image to the third image display apparatus in response to the detection of the connection of the third image display apparatus when the 3D conversion capability of the third image display apparatus is higher than a 3D conversion capability of the conversion module.

10. The apparatus of claim 8, wherein the controller is configured to execute control to output a 3D conversion instruction to the third image display apparatus.

11. The apparatus of claim 9, wherein the controller is configured to execute control to output a 3D conversion instruction to the third image display apparatus.

12. The apparatus of claim 5, wherein the conversion module is configured to convert the 3D image into the 2D image in response to the detection of the connection of the first image display apparatus, and
the controller is configured to execute control to output the 2D image to the first image display apparatus in response to the detection of the connection of the first image display apparatus.

13. An image output control method comprising:
detecting a capability of an image display apparatus; and
executing control to output one of a 2D image and a 3D image to the image display apparatus based on the capability.
